(19) United States
(12) Patent Application Publication
(10) Pub. No.: US 2015/0031001 A1
(43) Pub. Date: Jan. 29, 2015

(54) Calculus teaching and demonstration aid

(71) Applicant: Peter Hakel, Los Alamos, NM (US)

(72) Inventor: Peter Hakel, Los Alamos, NM (US)

(21) Appl. No.: 13/952,022

(22) Filed: Jul. 26, 2013

(51) Int. Cl. G09B 23/02

(52) U.S. Cl. CPC G09B 23/02
USPC 434/211

(57) ABSTRACT

The claimed calculus teaching and demonstration device has an internal volume in the shape of two perpendicular axes and a mathematical function that can be filled with a measured amount of liquid and thus used to illustrate the calculus concept of area under the curve.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM, LISTING COMPACT DISC APPENDIX

N/A

### BACKGROUND OF THE INVENTION

Teaching of introductory calculus invokes terms such as “the tangent of the slope” (differential calculus) and “the area under the curve” (integral calculus). These two main branches of calculus are linked by the fundamental theorem of calculus, which states that the definite integral of a function can be evaluated with the help of an anti-derivative of the said function evaluated at the boundaries of the integrated domain. The present invention provides with a hands-on illustration of these basic concepts with the goal of helping students learn and understand this subject matter.

I am not aware of any prior art in which the basic ideas of calculus are practically demonstrated in a manner described in this document.

### BRIEF SUMMARY OF THE INVENTION

FIG. 1 shows a front view of a prototype and FIG. 2 shows a side view of the same prototype. The device is manufactured from a non-fragile, water-impermeable material. The core of the device is in the shape of two mutually perpendicular straight arms that represent the x (1) and y (2) axes of a graph of a mathematical function. The curved part of the core (3) follows the graph of a manufacturer-chosen function y=f(x), which satisfies the following two criteria: a) its antiderivative is a known analytic function F(x), and, b) the chosen function value f(x) at the terminus of the horizontal axis (1) leaves a sufficient opening (4) for water to be poured in and out of the device. The core of the device is enclosed between two plates of a transparent, water-impermeable and non-fragile material (5), whose edges are parallel to the axes (1), (2), and enable the device to stand both upright and on its side on a level surface. The plates (5) carry axis tics markings (6) along the horizontal axis and the mathematical formula of the chosen function y=f(x) (7). Analogous markings along the vertical axis (2) are also possible, but not necessary. The contact between the two plates (5) and the core (1),(2),(3) is watertight, with (4) being the only opening. The distance between the two plates (5) equals one (1) unit of distance chosen for the axes (1) and (2).

### DETAILED DESCRIPTION OF A PROTOTYPE

In this prototype the adopted unit of distance is 1 centimeter, which is also the distance between the plates (5). The adopted mathematical function is:

y=f(x)=10−x²/10

with the variable x covering the interval between 0 (lower-limit of integration) up to 8. Its definite integral (with the lower-limit condition of F(0)=0) is:

F(x)=10 x−x³/30

### OPERATION OF THE INVENTION

The device is placed on its side (2) onto a level surface with the opening (4) located at the top (FIGS. 3 and 4). A buret is used to dispense a precisely measured amount of liquid, which in the device rises to a level that is measured along the x axis (1) (FIGS. 5 and 6). In this prototype the adopted unit of distance is 1 centimeter, which is also the distance between the plates (5). Therefore, the volume of liquid in cubic centimeters (or milliliters) dispensed by the buret is numerically equal to the area under the y=f(x) curve in the device measured in square centimeters. Since both the function f(x) and its antiderivative F(x) are known analytically, the student can experimentally verify the theoretical results predicted by integral calculus. Furthermore, when raising the liquid's level by a small additional amount dx by adding a little extra volume (area under the curve) dF, the student can observe the relationship:

dF=F(x+dx)−F(x)=f(x)dx

(i.e., f(x) is the derivative of F(x)) that connects integral and differential calculus through the fundamental theorem of calculus (FIGS. 5 and 6, with dx=6−5=1). The main idea is for the student to verify that the volume (area under the curve) represented by F(x) and computed from a formula agrees with the measured volume of liquid dispensed from the buret, e.g. by completing the last column of the following table:

| x | f(x) = 10 − x²/10 | F(x) = 10 x − x³/30 | F(x) measured |
|---|---|---|---|
| 0.0 | 10.0 | 0.0 | 0.0 |
| 1.0 | 9.9 | 10.0 | |
| 2.0 | 9.6 | 19.7 | |
| 3.0 | 9.1 | 29.1 | |
| 4.0 | 8.4 | 37.9 | |
| 5.0 | 7.5 | 45.8 | |
| 6.0 | 6.4 | 52.8 | |
| 7.0 | 5.1 | 58.6 | |
| 8.0 | 3.6 | 62.9 | |

As a welcome side benefit of using this invention, the student gets to practice the operation of the buret (relevant for his or her chemistry lab work) with a non-toxic liquid such as water.

### BRIEF DESCRIPTION OF THE DRAWINGS AND PHOTOGRAPHS

FIG. 1. Prototype (front view)

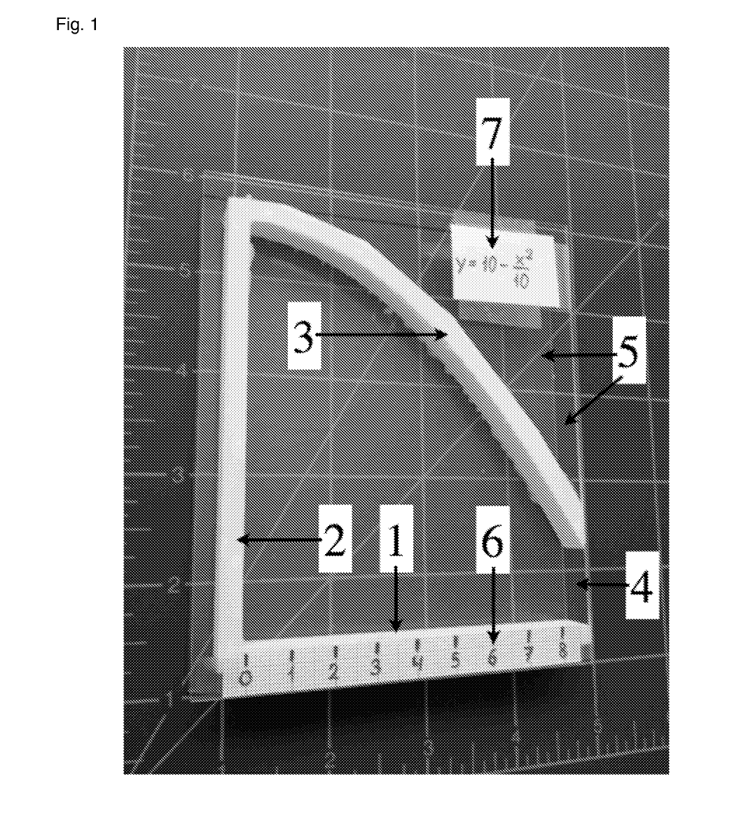

FIG. 2. Prototype (side view)

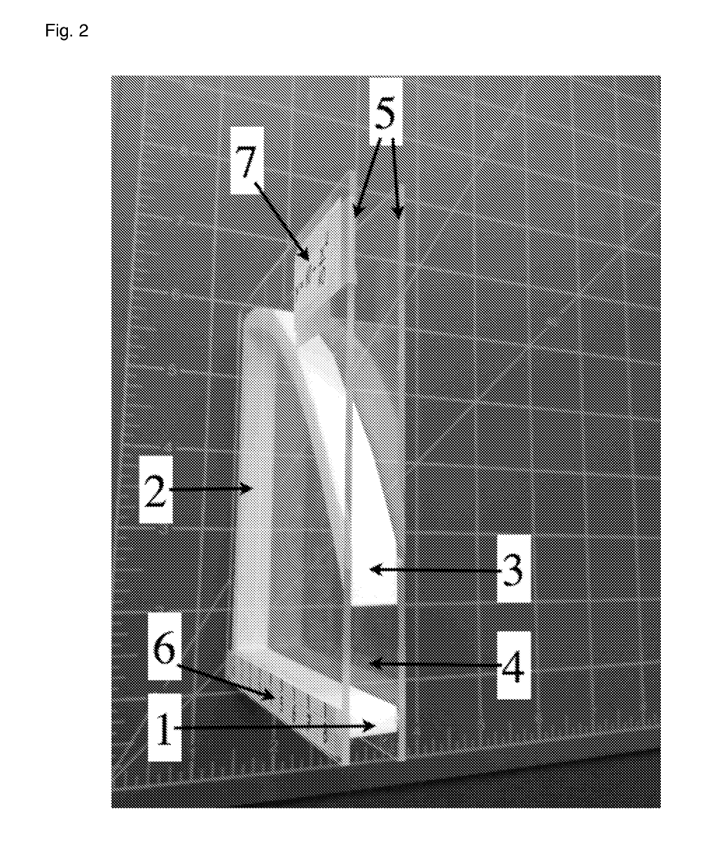

In the following Figures arrows indicate the surface level of the working liquid.

FIG. 3. Initial arrangement of the prototype with buret (x=0.0, F(x)=0.0)

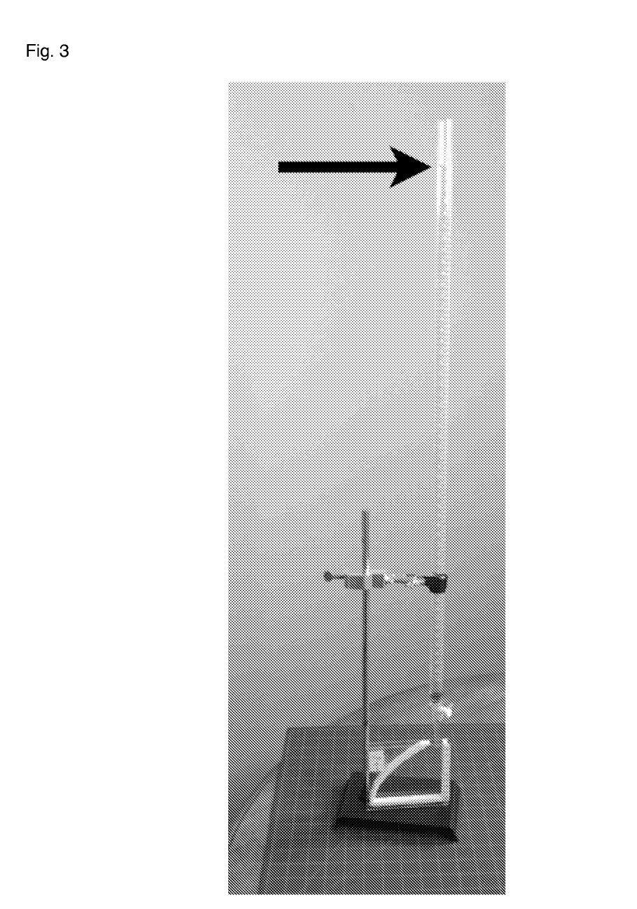

FIG. 4. Details of the initial arrangement of the prototype (4a) with buret (4b)

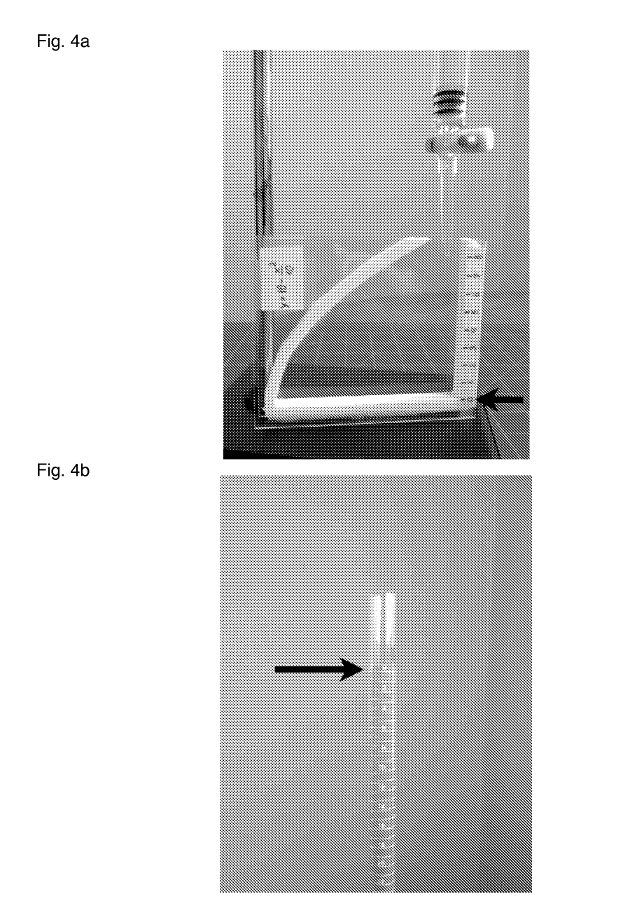

FIG. 5. Liquid level (5a, x=5.0) and dispensed volume (5b, F(x)=45.8)

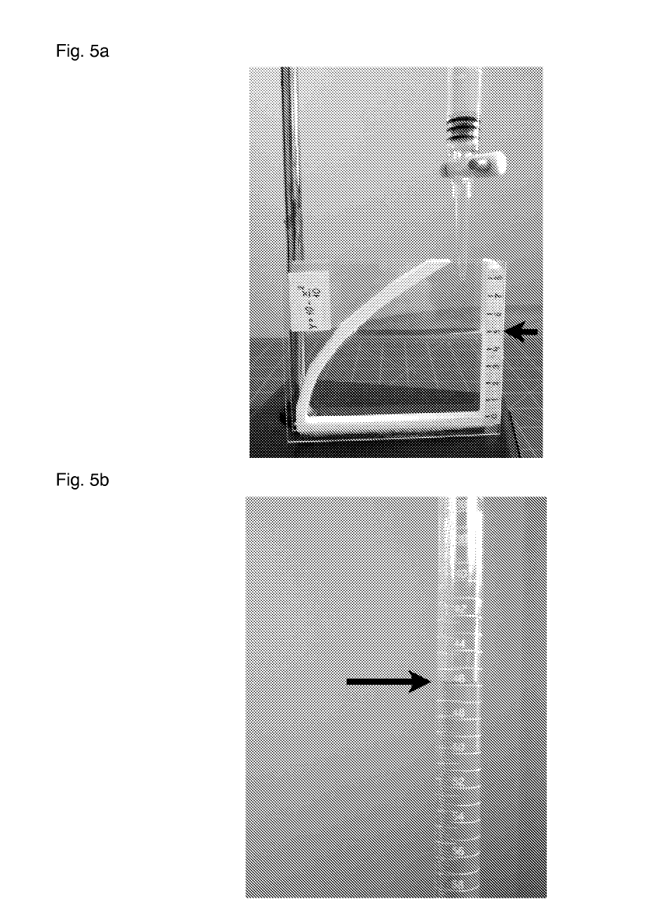

FIG. 6. Liquid level (6a, x=6.0) and dispensed volume (6b, F(x)=52.8)

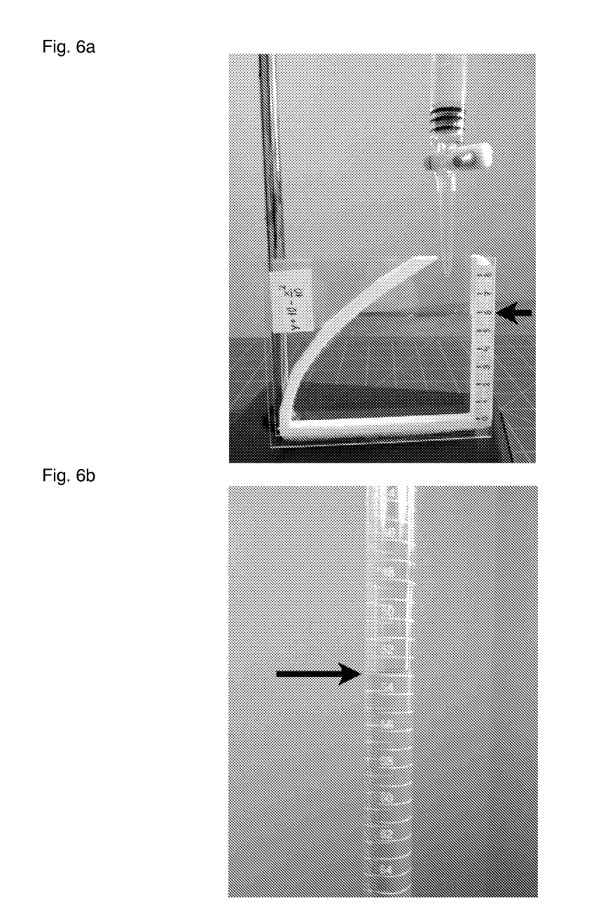

I claim:

1) A teaching and demonstration device whose internal volume in the shape of two perpendicular axes and a mathematical function can be filled with a measured amount of liquid and thus used to illustrate the calculus concept of area under the curve.
